(19) United States
(12) Patent Application Publication
(10) Pub. No.: US 2025/0129747 A1
(43) Pub. Date: Apr. 24, 2025

(54) NACELLE FOR A GAS TURBINE ENGINE

(71) Applicant: General Electric Company Polska sp. z o.o., Warsaw (PL)

(72) Inventor: Tomasz Iglewski, Warsaw (PL)

(21) Appl. No.: 18/592,651

(22) Filed: Mar. 1, 2024

(30) Foreign Application Priority Data
Oct. 23, 2023 (PL) P.446464

(51) Int. Cl. F02C 7/18; F01D 25/12; F01D 25/24

(52) U.S. Cl. CPC F02C 7/18; F01D 25/12; F01D 25/24; F05D 2220/323; F05D 2240/14; F05D 2260/213

(57) ABSTRACT

A nacelle for a gas turbine engine includes an interior portion along a radial direction of the gas turbine engine and a heat exchanger. The interior portion defines a heat exchanger duct including an inlet and an outlet. The heat exchanger is disposed in the heat exchanger duct between the inlet and the outlet. The inlet is disposed aft of the outlet along a central axis of the nacelle.

### CROSS-REFERENCE TO RELATED APPLICATIONS

The present application claims priority to Polish Patent Application Serial Number P.446464 filed on Oct. 23, 2023.

### FIELD

The present disclosure relates to a nacelle for a gas turbine engine, and in particular to heat exchangers for the nacelle of aircraft engines.

### BACKGROUND

Aircraft engines use air-cooled heat exchanger systems to cool various other components of the engine. Pressure differences between opposing sides of the heat exchanger drive air flow through the heat exchanger. Such pressure differences may result from dynamic head, a pressurized volume relative to ambient, and/or different flow streams within the engine. There remains an opportunity to use components of the engine to gain greater control of these pressure differences, thereby utilizing the heat exchanger more readily by increasing air flow therethrough.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of an exemplary turbofan gas turbine engine.

FIG. 2 is a magnified view of a portion of a nacelle of the gas turbine engine of FIG. 1 including a heat exchanger duct.

FIG. 3 is a cross-sectional view of an interior portion of the nacelle including an inlet and outlets of the heat exchanger duct.

FIG. 4 is another exemplary nacelle of a gas turbine engine with a heat exchanger duct extending to a lip.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The present disclosure is generally related to improving heat exchanger operation in a gas turbine engine by using a fan blade to increase air flow through the heat exchanger and to release the heated air back into the engine. Certain heat exchanger systems may either expel heated air outboard of the engine or be completely positioned downstream of the fan blade, away from ambient air pressure. These systems may lose heated and/or pressurized air that could improve efficient operation of the engine and/or reduce air flow by lacking access to ambient air pressure.

To improve operation of heat exchanger systems, an inlet of a heat exchanger duct is disposed aft of the fan blade in order to gain the benefit of a pressure increase caused by rotation of the fan blade. The air then flows in a direction opposite to the air flow in the engine and through the heat exchanger. Upon heating by the heat exchanger, the heated air moves through an outlet that is disposed forward of the fan blade. By disposing the outlet forward of the fan blade, the heated air is expelled to a location at an ambient air pressure, which provides a pressure difference to cause air flow through the heat exchanger. The outlet is disposed within a fan duct such that the heated air returns to the fan blade, keeping the heated air within the engine and improving engine efficiency.

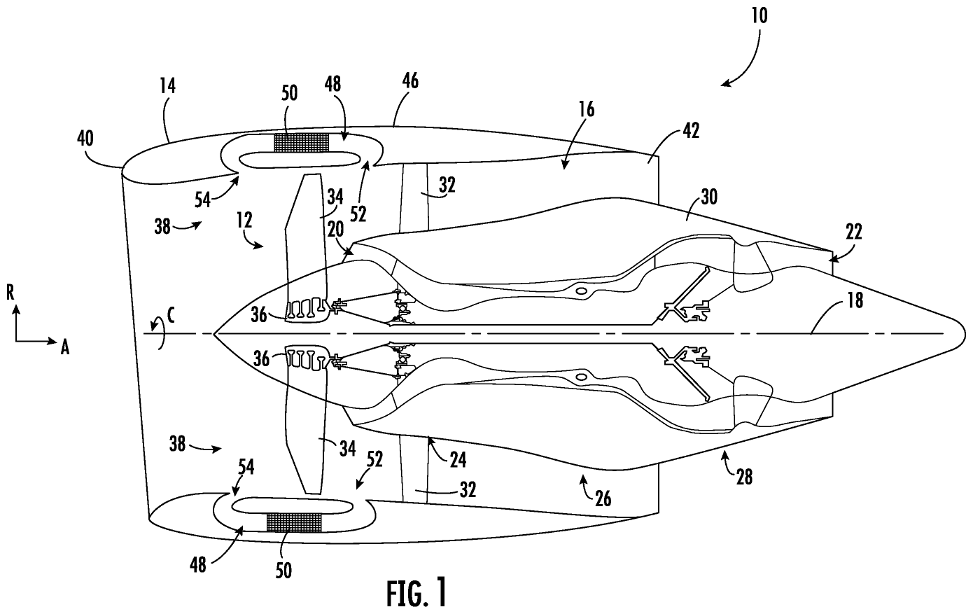

Referring now to the drawings, wherein identical numerals indicate the same elements throughout the figures, FIG. 1 illustrates an exemplary aircraft turbofan gas turbine engine 10, referred to herein as engine 10, including a fan 12, a nacelle 14 extending around the fan, and a turbomachine 16, all circumscribed about a central axis 18. The engine 10 defines an axial direction A along the central axis 18, a radial direction R radially away from the central axis 18, and a circumferential direction C around the central axis 18.

The turbomachine 16 defines a working gas flowpath extending from a turbomachine inlet 20 to a turbomachine exhaust 22, and includes a compressor section 24, a combustion section 26, and a turbine section 28 arranged in serial flow order. The compressor section 24, the combustion section 26, and the turbine section 28 define in part the working gas flowpath and generate rotational torque provided to the fan 12 during operation of the engine 10 through an output shaft. The turbomachine 16 further includes an outer casing 30 surrounding, at least in part, the compressor section 24, the combustion section 26, and the turbine section 28.

Notably, for the embodiment depicted, the nacelle 14 further extends around at least a portion of the turbomachine 16, and more specifically around at least a portion of the outer casing 30 of the turbomachine 16. The turbomachine 16 is supported relative to the nacelle 14 by a plurality of outlet guide vanes 32.

The fan 12 includes at least one row of fan blades 34 extending radially outward from a rotor disk 36. The fan blades 34 are at least partially positioned within the nacelle 14 and the engine 10 suitably designed to be mounted to a wing or fuselage of an aircraft. The nacelle 14 defines a fan duct 38, an engine inlet 40, and a fan duct exhaust 42, with the fan duct 38 extending from the engine inlet 40 to the fan duct exhaust 42. In such a manner, it will be appreciated that the fan blades 34 are disposed in the fan duct 38, and the fan duct 38 extends over the turbomachine 16 (and is defined in part between the outer casing of the turbomachine 16 and the nacelle 14).

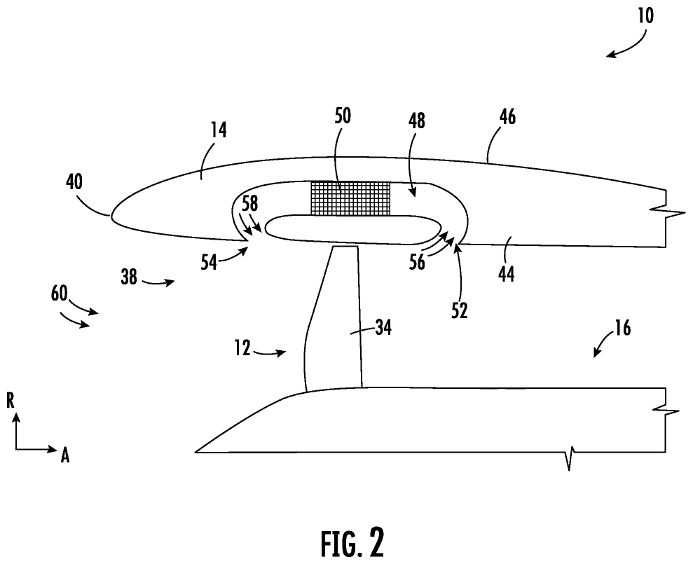

With reference to FIG. 2, the nacelle 14 includes an interior portion 44 along the radial direction R and an exterior surface 46. The interior portion 44 of the nacelle 14 faces the interior of the gas turbine engine 10, in particular the fan duct 38. The exterior surface 46 of the nacelle 14 encloses the turbomachine 16, and the interior portion 44 is the portion of the nacelle 14 radially inward of the exterior surface 46. In the embodiment depicted, the engine inlet 40 defined by the nacelle 14 includes the forwardmost portion of the interior portion 44 of the nacelle 14, i.e., a portion of the nacelle 14 through which ambient air from outside the engine 10 enters the fan duct 38.

The interior portion 44 defines a heat exchanger duct 48 therein. The heat exchanger duct 48 is a passage through which air from the fan duct 38 flows to a heat exchanger 50, described in further detail below. The heat exchanger duct 48 defines an inlet 52 and an outlet 54. The inlet 52 and the outlet 54 are in fluid communication with the fan duct 38, and more specifically are in direct fluid communication with the fan duct 38 (i.e., receive air flow directly from the fan duct 38 and provide air flow directly to the fan duct 38). Such a configuration allows an air flow 56 in the fan duct 38 of the gas turbine engine 10 to enter the inlet 52 and a heated air flow 58 to exit the outlet 54 back into the fan duct 38 of the gas turbine engine 10. Specifically, the outlet 54 expels air flow 58 to the fan duct 38 directly, inhibiting air flowing through the heat exchanger duct 48 from exiting outboard and away from the gas turbine engine 10 (at least without first exiting through the fan duct exhaust 42 (see FIG. 1)).

The inlet 52 is disposed aft of the outlet 54 along the central axis 18 of the nacelle 14. The inlet 52 receives the air flow 58 that is increased in air pressure by the fan 12, and the outlet 54 releases the air flow 58 upstream of the fan 12. The outlet 54 is positioned in the nacelle 14 such that air flow 58 is expelled to an ambient air flow 60 in the fan duct 38, i.e., air at ambient air pressure. As will be appreciated, the terms “ambient air pressure” or “ambient pressure” refer to a pressure at a location (e.g., an air pressure at the location) consistent with the air not having passed through a stage of compression rotor blades of the engine 10 (e.g., the fan 12, a compressor of the turbomachine 16, etc.).

In the exemplary embodiment depicted, air flow through the heat exchanger duct 48 is caused by a dynamic head, i.e., a difference between total pressure at the inlet 52 and a static pressure at the outlet 54. The inlet 52 and the outlet 54 are arranged such that the increased pressure at the inlet 52 and the ambient pressure at the outlet 54 provides the dynamic head to drive air through the heat exchanger duct 48.

The inlet 52 and the outlet 54 are arranged within the nacelle 14 such that a flow direction of air through the heat exchanger duct 48 opposes a flow direction of air through the fan duct 38. More specifically, the air flow through at least a section of the heat exchanger duct 48 includes an axial component in an aft to forward axial direction, whereas the air flow through the fan duct 38 includes an axial component in a forward to aft axial direction.

More specifically, because the air pressure of the air flow 60 through the fan duct 38 is higher downstream of the fan blades 34, to provide the dynamic head to drive flow through the heat exchanger duct 48, the inlet 52 is positioned downstream of the outlet 54. The downstream position of the inlet 52 receives air flow 56 at a higher pressure than the ambient air flow 60 through the fan duct 38 at the outlet 54, providing the dynamic head described above.

As noted above, the nacelle 14 includes the heat exchanger 50 disposed in the heat exchanger duct 48 between the inlet 52 and the outlet 54. The heat exchanger 50 is configured to use air flowing from the inlet 52 to the outlet 54 to cool another fluid, such as oil, flowing through the heat exchanger 50. That is, the heat exchanger 50 transfers heat from the oil to the air, thereby heating the air flowing through the heat exchanger 50 and cooling the oil. The heat exchanger 50 may be a conventional heat exchanger, such as a parallel flow heat exchanger, a cross flow heat exchanger, or a counter flow heat exchanger.

It will be appreciated, however, that in other exemplary embodiments, any other suitable heat exchanger may be utilized as the heat exchanger 50. For example, in other exemplary embodiments, the heat exchanger 50 may be a surface heat exchanger positioned in the heat exchanger duct 48 (e.g., integrated into the walls of the heat exchanger duct 48), may be an air-to-air heat exchanger (e.g., cooling an air flow through the nacelle 14 provided to one or more components within the nacelle), etc.

Referring still to FIG. 2, the heated air flow 58 may be used in the gas turbine engine 10 to improve operation of the engine 10. In particular, by re-integrating the heated air flow 58 into the fan duct 38 (as opposed to exhausting the heated air flow 58 outboard of the nacelle 14), the energy within the heated air flow 58 in the form of heat and higher pressure may be conserved within the fan duct 38, resulting in more efficient thrust from the engine 10.

Additionally, in one example, the heated air flow 58 may be provided onto a component, heating the component to melt accumulated ice or to inhibit ice formation, i.e., to “de-ice” the component. That is, ice formation on components may reduce performance of the gas turbine engine 10 by disrupting air flow past the component or inhibiting actuation of the component. The heated air flow 58 may be used in the removal of accumulated ice and inhibition of ice formation. The heated air flow 58 may be provided to the component upstream of the outlet 54 (not shown), or downstream of the outlet 54 (e.g., an inner surface of the nacelle 14).

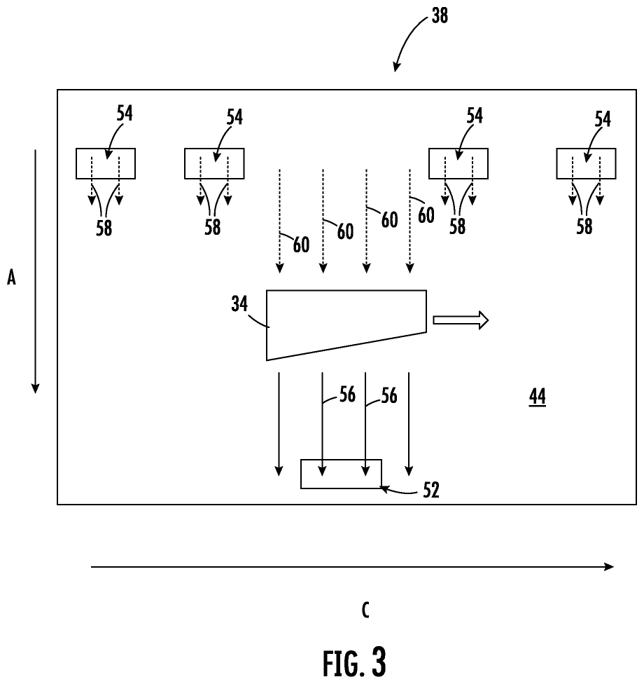

With reference to FIG. 3, an interior view looking radially outward of the gas turbine engine 10 is shown. The fan blade 34 moves in the circumferential direction C, pushing air at least partially in the axial direction A. Ambient air flow 60 shown in dashed lines represents ambient air that has not reached the fan blades 34. The fan blades 34 increase the pressure of the ambient air flow 60. The inlet 52 is disposed downstream of the fan blade 34, receiving at least some of the air flow 56 pushed/pressurized by the fan blade 34. A plurality of outlets 54 are arranged upstream of the fan blade 34 to return heated air flow 58 to the fan duct 38, which is also shown with dashed lines because the heated air flow 58 returns to a location within the fan duct 38 at an ambient air pressure. The outlets 54 depicted are arranged circumferentially around the interior portion 44 of the nacelle 14 to distribute the heated air flow 58 through the fan duct 38.

The inlet 52 and the outlets 54 may be “clocked” in the nacelle 14, i.e., disposed at different circumferential positions around the interior portion 44 of the nacelle 14. The clocked inlet 52 and outlets 54 inhibit heated air flow 58 from exiting the outlet 54 and then returning to the inlet 52, i.e., “air recirculation” into the inlet 52. Inhibiting air recirculation improves the efficiency of the heat exchanger 50 by directing cool air flows into the heat exchanger duct 48. That is, the efficiency of the heat exchanger 50 is based at least in part on the temperature difference between the air entering the heat exchanger 50 and the other fluid of the heat exchanger 50, which is oil in the example of FIGS. 2-3. When heated air is reintroduced to the heat exchanger 50, the temperature difference is low, and the heat exchanger 50 may only increase the temperature of the air slightly because less heat would be transferred from the oil to the air. When cool air is introduced to the heat exchanger 50, the temperature difference is high, and more heat is transferred from the oil to the cool air. Because the efficiency of the heat exchanger 50 is improved, smaller heat exchangers 50 may be used, addressing weight and size constraints on the gas turbine engine 10.

Additionally, it will be appreciated that although for the embodiment depicted in FIG. 3 the nacelle 14 includes a single inlet 52 and a plurality of outlets 54, in other embodiments, the nacelle 14 may additionally include a plurality of inlets 52, each inlet 52 clocked relative to each of the outlets 54 to inhibit air recirculation into the inlets 52. With such a configuration, each inlet 52 may correspond to a dedicated outlet 54, and the heat exchanger duct 48 may include a plurality of heat exchanger ducts 48 extending between a respective inlet 52 and outlet 54.

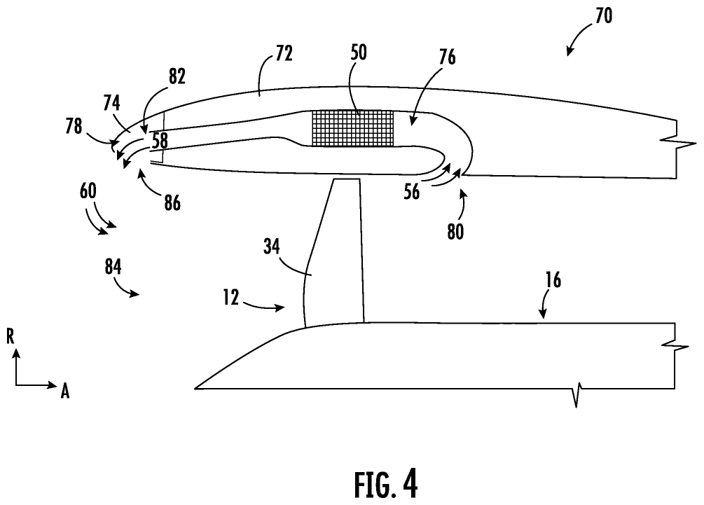

With reference to FIG. 4, another exemplary gas turbine engine 70 is shown. The gas turbine engine 70 of FIG. 4 may be configured in a similar manner as the exemplary gas turbine engine 10 described above with reference to FIGS. 1 through 3, and the same or similar numbers may refer to the same or similar parts.

For the embodiment of FIG. 4, a gas turbine engine 70, also referred to herein as engine 70, includes a nacelle 72 including a lip 74 disposed at a forward end of the nacelle 72. The lip 74 refers to a forward 10% of the nacelle 72. As mentioned above, reducing ice formation on components of the engine 70 may improve operation of the engine 70. When ice accumulates on the lip 74, air flow into the engine 70 may be disrupted and/or reduced. De-icing the lip 74 improves the air flow into the engine 70, and a heat exchanger duct 76 may be arranged such that a heat exchanger 50 provides heated air to de-ice the lip 74.

The lip 74 defines a cavity 78 that is in fluid communication with the heat exchanger duct 76. In the exemplary nacelle 72 of FIG. 4, ambient air flow 60 flows past the fan blade 34 and into an inlet 80 of the heat exchanger duct 76 as an air flow 56, through the heat exchanger 50, and to an outlet 82 of the heat exchanger duct 76, which is disposed at the lip 74 (e.g., positioned within the lip 74 or opening into the lip 74) and faces the cavity 78. Heated air flow 58 from the heat exchanger 50 is expelled through the outlet 82 and into the cavity 78. The heated air flow 58 in the cavity 78 heats the lip 74, melting any accumulated ice and inhibiting further ice production on the lip 74. Thus, de-icing the lip 74 with the heated air flow 58 output from the heat exchanger duct 76 improves performance of the engine 70.

The lip 74 may be in fluid communication with a fan duct 84 through a lip opening 86 on an inner side of the nacelle 72. Heated air flow 58 from the outlet 82 flows through the cavity 78 to heat the lip 74, and the heated air flow 58 then flows through the lip opening 86 back into the fan duct 84. As with the outlets 54 shown in FIG. 3, the lip opening 86 may be clocked relative to the inlet 80 of the heat exchanger duct 76 to inhibit recirculation of the heated air flow 58 from the lip opening 86 to the heat exchanger 50. Additionally, not shown in the FIGS., the lip 74 may include a plurality of lip openings 86 disposed circumferentially around the nacelle 72, each of the plurality of lip openings 86 may be clocked relative to the inlet 80. As an example, the plurality of lip openings 86 may be positioned around the entire circumference of the lip 74 to increase the amount of the heated air flow 58 flowing into the fan duct 84. Further aspects are provided by the subject matter of the following clauses:

A nacelle for a gas turbine engine defining a radial direction, the nacelle including an interior portion along the radial direction defining a heat exchanger duct, the heat exchanger duct comprising an inlet and an outlet; and a heat exchanger disposed in the heat exchanger duct between the inlet and the outlet, wherein the inlet is disposed aft of the outlet along a central axis of the nacelle.

The nacelle of any of the previous clauses, wherein the inlet and the outlet are disposed at different circumferential positions around the interior portion.

The nacelle of any of the previous clauses, further comprising a lip at a forward end of the nacelle, wherein the outlet is disposed at the lip.

The nacelle of any of the previous clauses, wherein the outlet is arranged to expel air from the heat exchanger to a fan duct of the gas turbine engine.

The nacelle of any of the previous clauses, wherein the heat exchanger duct further comprises a plurality of outlets arranged circumferentially around the nacelle.

The nacelle of any of the previous clauses, wherein the outlet is configured to expel air to an air flow at ambient air pressure.

The nacelle of any of the previous clauses, wherein the heat exchanger is configured to heat air flowing from the inlet to the outlet.

The nacelle of any of the previous clauses, wherein the inlet and the outlet are in fluid communication with a fan duct of the gas turbine engine.

A gas turbine engine defining a radial direction, the gas turbine engine including a nacelle defining a fan duct, the nacelle including an interior portion along the radial direction defining a heat exchanger duct, the heat exchanger duct comprising an inlet and an outlet; and a heat exchanger disposed in the heat exchanger duct between the inlet and the outlet; and a fan blade disposed within the fan duct, wherein the inlet is disposed aft of the fan blade along a central axis of the nacelle and the outlet is disposed forward of the fan blade along the central axis of the nacelle.

The gas turbine engine of any of the previous clauses, wherein the fan blade is configured to increase an air pressure in the fan duct to direct air into the inlet.

The gas turbine engine of any of the previous clauses, wherein the inlet and the outlet are disposed at different circumferential positions around the interior portion.

The gas turbine engine of any of the previous clauses, wherein the nacelle further comprises a lip at a forward end of the nacelle, wherein the outlet is disposed at the lip and is configured to expel air into the lip.

The gas turbine engine of any of the previous clauses, wherein the lip defines a cavity in fluid communication with the heat exchanger duct and the fan duct, and the outlet is arranged to direct the air from the heat exchanger to the cavity.

The gas turbine engine of any of the previous clauses, wherein the outlet is arranged to expel air from the heat exchanger to the fan duct.

The gas turbine engine of any of the previous clauses wherein the heat exchanger duct further comprises a plurality of outlets arranged circumferentially around the nacelle.

The gas turbine engine of any of the previous clauses, wherein the inlet and the outlet are in fluid communication with the fan duct.

The gas turbine engine of any of the previous clauses, wherein the outlet is configured to expel air to an air flow at ambient air pressure.

The gas turbine engine of any of the previous clauses, wherein the heat exchanger is configured to heat air flowing from the inlet to the outlet.

The gas turbine engine of any of the previous clauses, wherein the outlet is arranged to direct the heated air exiting the outlet onto a component to de-ice the component.

The gas turbine engine of any of the previous clauses, wherein a flow direction of air through the heat exchanger duct opposes a flow direction of air through the fan duct.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A nacelle for a gas turbine engine defining a radial direction, the nacelle comprising:
an interior portion along the radial direction defining a heat exchanger duct, the heat exchanger duct defining an inlet and an outlet; and
a heat exchanger disposed in the heat exchanger duct between the inlet and the outlet,
wherein the inlet is disposed aft of the outlet along a central axis of the nacelle.

2. The nacelle of claim 1, wherein the inlet and the outlet are disposed at different circumferential positions around the interior portion.

3. The nacelle of claim 1, further comprising a lip at a forward end of the nacelle, wherein the outlet is disposed at the lip.

4. The nacelle of claim 1, wherein the outlet is arranged to expel air from the heat exchanger to a fan duct of the gas turbine engine.

5. The nacelle of claim 1, wherein the heat exchanger duct further comprises a plurality of outlets arranged circumferentially around the nacelle.

6. The nacelle of claim 1, wherein the outlet is configured to expel air to an air flow at ambient air pressure.

7. The nacelle of claim 1, wherein the heat exchanger is configured to heat air flowing from the inlet to the outlet.

8. The nacelle of claim 1, wherein the inlet and the outlet are in fluid communication with a fan duct of the gas turbine engine.

9. A gas turbine engine defining a radial direction, the gas turbine engine comprising:
a nacelle defining a fan duct, the nacelle comprising:
an interior portion along the radial direction defining a heat exchanger duct, the heat exchanger duct defining an inlet and an outlet; and
a heat exchanger disposed in the heat exchanger duct between the inlet and the outlet; and
a fan blade disposed within the fan duct,
wherein the inlet is disposed aft of the fan blade along a central axis of the nacelle and the outlet is disposed forward of the fan blade along the central axis of the nacelle.

10. The gas turbine engine of claim 9, wherein the fan blade is configured to increase an air pressure in the fan duct.

11. The gas turbine engine of claim 9, wherein the inlet and the outlet are disposed at different circumferential positions around the nacelle.

12. The gas turbine engine of claim 9, wherein the nacelle further comprises a lip at a forward end of the nacelle, wherein the outlet is disposed at the lip and is configured to expel air into the lip.

13. The gas turbine engine of claim 12, wherein the lip defines a cavity in fluid communication with the heat exchanger duct and the fan duct, and the outlet is arranged to direct the air from the heat exchanger to the cavity.

14. The gas turbine engine of claim 9, wherein the outlet is arranged to expel air from the heat exchanger to the fan duct.

15. The gas turbine engine of claim 9, wherein the heat exchanger duct further comprises a plurality of outlets arranged circumferentially around the nacelle.

16. The gas turbine engine of claim 9, wherein the inlet and the outlet are in fluid communication with the fan duct.

17. The gas turbine engine of claim 9, wherein the outlet is configured to expel air to an air flow at ambient air pressure.

18. The gas turbine engine of claim 9, wherein the heat exchanger is configured to heat air flowing from the inlet to the outlet.

19. The gas turbine engine of claim 18, wherein the outlet is arranged to direct the heated air exiting the outlet onto a component to de-ice the component.

20. The gas turbine engine of claim 9, wherein a flow direction of air through the heat exchanger duct opposes a flow direction of air through the fan duct.
